(19) United States
(12) Patent Application Publication
(10) Pub. No.: US 2024/0393471 A1
(43) Pub. Date: Nov. 28, 2024

(54) METHOD AND DEVICE FOR DETECTING SATELLITE SIGNAL SPOOFING

(71) Applicant: Safran Electronics & Defense, PARIS (FR)

(72) Inventors: Loïc DAVAIN, MOISSY-CRAMAYEL (FR); Fabrice DELHAYE, MOISSY-CRAMAYEL (FR); Alain Michel CHIODINI, MOISSY-CRAMAYEL (FR)

(73) Assignee: Safran Electronics & Defense, PARIS (FR)

(21) Appl. No.: 18/698,134

(22) PCT Filed: Oct. 7, 2022
(86) PCT No.: PCT/FR2022/051898

§ 371 Date: Apr. 3, 2024

(30) Foreign Application Priority Data
Oct. 7, 2021 (FR) FR2110596

(51) Int. Cl. G01S 19/21; G01S 19/24

(52) U.S. Cl. CPC G01S 19/215; G01S 19/24

(57) ABSTRACT

A method comprising steps of: performing spatial filtering (104, 204) causing an attenuation of power of radio signals received by an antenna system in an angular sector (A); detecting (106, 206, 210) that a radio signal is received by the antenna system while the angular sector (A) includes a direction pointing at a satellite (S1) forming part of a constellation of positioning satellites, that the received radio signal is not subject to the attenuation caused by the spatial filtering, and that the received radio signal is in the form of a positioning signal emanating from the satellite (S1); and, following the detection, implementing processing (112, 114, 212, 214) under the assumption that the antenna system has fallen victim to decoying.

### FIELD OF THE INVENTION

The present invention relates to a method and a device for detecting satellite signal spoofing.

### STATE OF THE ART

The use of positioning satellites for geolocation purposes is well known. Conventionally, a mobile carrier can determine its position based on radio signals (GNSS signals) which emanate from satellites forming a constellation.

Spoofing is a transmission by an emitter of false GNSS signals for malicious purposes, for example to distort the position measurement.

### DISCLOSURE OF THE INVENTION

One aim of the invention is to detect satellite spoofing in a simple and effective manner.

For this purpose, according to a first aspect, a method is proposed comprising steps of:
performing spatial filtering causing an attenuation of power of radio signals received by an antenna system in an angular sector,
detecting that a radio signal is received by the antenna system while the angular sector includes a direction pointing towards a satellite forming part of a constellation of positioning satellites, that the received radio signal is not subject to the attenuation caused by the spatial filtering, and that the received radio signal appears as a positioning signal emanating from the satellite,
following the detection, implementing a processing under the assumption that the antenna system is the victim of spoofing.

The method according to the first aspect is based on the idea that a radio signal which appears as a positioning signal emanating from a satellite can only come from two types of alternative sources: the satellite belonging to the constellation of satellites (to which case this radio signal is an authentic signal), or an emitter which attempts to spoof the antenna system by pretending to be the satellite (in which case the signal is a spurious signal). As, during the detection, the angular sector includes a direction pointing towards the satellite of the constellation, a radio signal emitted by this satellite and propagating towards the antenna system in this direction is necessarily subject to the attenuation caused by the spatial filtering. However, a signal is detected which appears as a positioning signal emanating from the satellite during this angular filtering, but which is not subject to such attenuation. As this signal cannot emanate from the satellite, it is deduced that it is a spoofing signal emitted by another emitter.

The method according to the first aspect can also comprise the following optional characteristics, taken alone or combined together when possible.

Preferably, the detection is repeated for several satellites forming part of the constellation.

Preferably, the processing comprises steps of:
detecting that a second signal appearing as a positioning signal emanating from a satellite forming part of the constellation is subject to an attenuation caused by the spatial filtering while the angular sector does not include any direction pointing towards any satellite of the constellation,
identifying a direction included in the angular sector during the detection as a direction pointing towards an emitter at the origin of the spoofing.

Preferably, the processing comprises steps of:
detecting that second signals appearing respectively as positioning signals emanating from different satellites forming part of the constellation are simultaneously subject to the attenuation caused by the spatial filtering while the angular sector does not include any direction pointing towards any satellite of the constellation,
identifying a direction included in the angular sector during the detection as a direction pointing towards a jammer.

Preferably, the antenna system is in a mobile carrier, and the processing comprises a step of:
performing spatial filtering so as to maintain the direction identified in the angular sector during a displacement of the mobile carrier.

Preferably, the spatial filtering is adapted so that the attenuation does not interrupt the tracking, by a GNSS receiver coupled to the antenna system, of a satellite in the constellation.

In one embodiment, the method according to the first aspect comprises steps of:
determining the direction pointing towards the satellite before the implementation of the spatial filtering,
controlling the antenna system based on the determined direction, so as to orient the angular sector in the determined direction.

In another embodiment, the method comprises steps of:
controlling the antenna system so as to move the angular sector in rotation, the angular sector occupying a succession of orientations during the rotational displacement,
during the rotational displacement, detecting that the angular sector includes the direction pointing towards the satellite.

Preferably, the method comprises a step of determining the direction pointing towards the satellite from an attitude of a carrier comprising the antenna system, the attitude being determined based on data provided by an inertial unit.

Preferably, the antenna system comprises at least three planar antennas.

It is also proposed, according to a second aspect, a device comprising:
an antenna system configured to apply spatial filtering causing an attenuation of power of radio signals received by the antenna system in an angular sector,
a detection module configured:
   to detect that a radio signal is received by the antenna system while the angular sector includes a direction pointing towards a satellite forming part of a constellation of positioning satellites, that the received radio signal is not subject to the attenuation caused by the spatial filtering, that the received radio signal appears as a positioning signal emanating from the satellite, and
   following the detection, to implement a processing under the assumption that the antenna system is the victim of spoofing.

This device can be included in a mobile carrier, such as an aircraft.

### DESCRIPTION OF THE FIGURES

Other characteristics, aims and advantages of the invention will emerge from the following description, which is purely illustrative and not limiting, and which should be read with reference to the appended drawings.

FIG. 1 represents a constellation of satellites, a jammer and a mobile carrier.

FIG. 2 schematically illustrates a device included in the mobile carrier, according to one embodiment.

FIG. 3 is a flowchart of steps of a method implemented by the device, according to a first embodiment.

FIG. 4 is a flowchart of steps of a method implemented by the device, according to a second embodiment.

In all the figures, similar elements bear identical references.

### DETAILED DESCRIPTION OF THE INVENTION

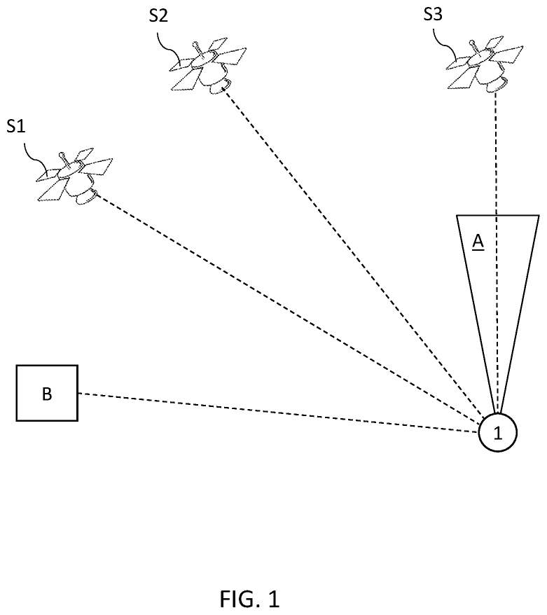

Referring to FIG. 1, a constellation comprises a plurality of positioning satellites. Only three satellites S1, S2, S3 are represented in FIG. 1, it being understood that the constellation can comprise a greater number of satellites.

Each satellite of the constellation is able to emit radio positioning signals (GNSS signals), likely to be received and exploited by a mobile carrier 1, for example to allow the carrier 1 to be located in space. In a manner known per se, the signals emitted by different satellites of the constellation carry data that allow identifying the satellite from which they emanate. In other words, by its content, a signal appearing as emanating from a satellite Si is distinguished from a signal appearing as emanating from a satellite Sj.

FIG. 1 also represents the mobile carrier 1, such as an aircraft, which is capable of receiving the radio signals emitted by the satellites of the constellation. These signals are in principle received by the carrier 1 in different directions, which are indicated in FIG. 1 by dotted lines, due to the respective positions of the satellites S1, S2, S3.

FIG. 1 also represents an emitter B whose objective is to spoof the mobile carrier 1. For this purpose, the emitter B can be configured to emit a radio signal which appears as a positioning signal emanating from a satellite of the constellation, or be configured to emit a plurality of signals which respectively appear as positioning signals emanating from different satellites of the constellation (even all the satellites of the constellation).

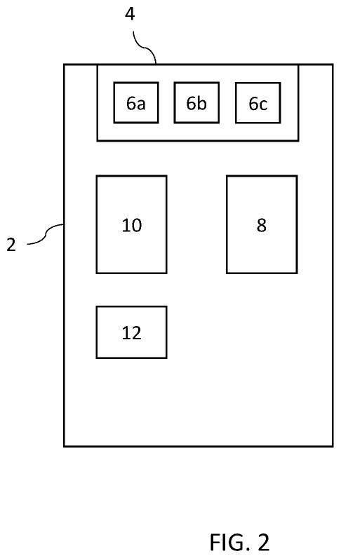

With reference to FIG. 2, the mobile carrier 1 comprises a device 2.

The device 2 comprises an antenna system 4 (also called antenna array). The antenna system 4 is capable of receiving signals propagating in different directions in space, particularly signals emanating from the satellites S1, S2, S3 and the jammer B.

Generally, the antenna system 4 is configured to implement a technique known as spatial filtering, also called beamforming. The spatial filtering makes it possible to modify the radiation pattern of the antenna system 4. The radiation pattern is the graphic representation of the angular distribution of a quantity characterizing the radiation of a radio antenna and, by extension, this distribution itself.

The antenna system 4 is adapted to implement spatial filtering which causes an attenuation of power of signals received by the antenna system 4 in an angular sector A, and whose orientation can be modified. This specific attenuation is not experienced by signals received by the antenna system 4 in directions located outside the angular sector A. In the following, this angular sector A is called attenuation sector A.

The attenuation sector A is a three-dimensional area extending from a main direction of attenuation. In FIG. 1, this attenuation sector A is ideally represented as a cone, but it is only a schematic representation simply intended to facilitate the understanding of the spatial filtering carried out by the antenna system 4. In FIG. 1, the main direction of attenuation points towards the satellite S3.

The attenuation can be particularly pushed to the point of eliminating a signal received in the angular sector A. This technique is known in the literature under the name “null steering”. Reference can for example be made to the document “Null steering based beamforming techniques” by Leng, Shuang.

To apply spatial filtering which generates such an attenuation sector A, the antenna system comprises a plurality of antennas 6a, 6b, 6c, also called “antenna elements” in the literature. The antenna system can comprise two antennas, three antennas as represented in FIG. 2 or more.

The geometric shape of the attenuation sector A depends on the type and on the number of antennas comprised in the antenna system 4.

Having three antennas 6a, 6b, 6c makes it possible to obtain an attenuation sector A which is narrower than with two antennas. The more the number of antennas of the antenna system 4 is increased, the more the antenna system 4 is capable of producing a narrow attenuation sector A.

The antennas 6a, 6b, 6c are for example planar antennas, sometimes called “patch” antennas.

The device 2 also comprises a GNSS receiver 8. The GNSS receiver 8 is adapted to analyze the content of radio signals received by the antenna, and in particular to recognize among such signals positioning signals emitted by the satellites of the constellation. Once recognized by the GNSS receiver 8, positioning signals emitted by the satellites S1, S2, S3 can be exploited by the GNSS receiver 8, for example to determine a position of the carrier 1. By convention, it is said that the GNSS receiver 8 “tracks” a satellite when the signal emanating from it can be used to determine such a position of the carrier 1 or more generally to calculate a PVT solution.

The device 2 moreover comprises a detection module 10. One function of the detection module 10 is to detect spoofing, or to locate and exclude a jammer responsible for it. This detection module 10 is adapted to analyze radio signals received by the antenna system 4, and check whether or not these signals verify some conditions which will be explained later.

The detection module 10 comprises or is coupled to a memory in which location data of the satellites in the constellation are stored. These location data comprise, for example, respective positions of these satellites, known in advance.

The detection module 10 is also capable of monitoring the spatial filtering generated by the antenna system 4. The detection module 10 is particularly capable of controlling the antenna system 4, so as to be able to vary the orientation of the main direction of attenuation and therefore more generally the orientation of the attenuation sector A.

The detection module 10 is also capable of controlling the antenna system 4, so as to be able to vary the amplitude of the attenuation caused in the sector A.

The detection module 10 can be integrated into the antenna system 4, into the GNSS receiver 8, or be in the form of an electronic component distinct from the antenna system and the GNSS receiver 8. The detection module 10 typically comprises at least one of the following components: processor, microprocessor, programmable or non-programmable circuit, for example of the FPGA, ASIC type, etc.

The device 2 also comprises an inertial unit 12 (inertial Navigation System (INS)). The inertial unit 12 is configured to estimate a position of the carrier 1, a speed of the carrier 1 and an attitude of the carrier 1, that is to say an orientation of the carrier 1 in a predefined reference frame. For this purpose, the inertial unit 12 comprises a plurality of inertial sensors, such as accelerometers and/or gyrometers, providing measurements based on which the attitude can be estimated.

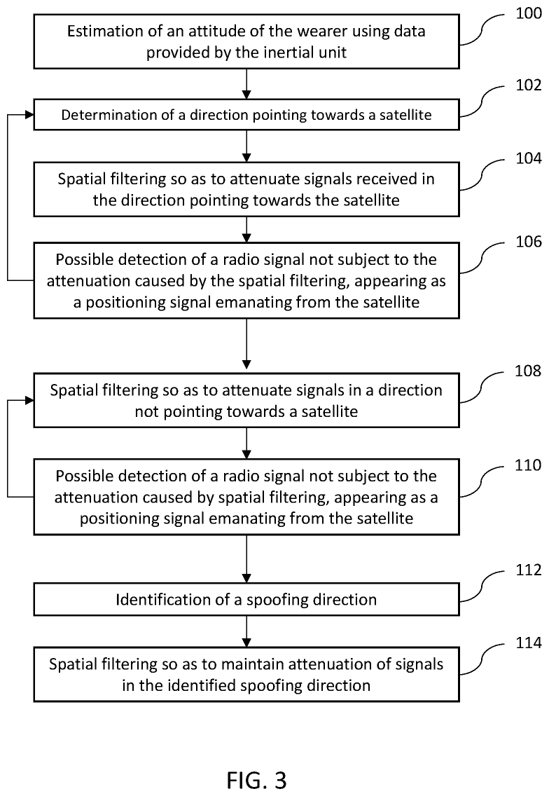

With reference to FIG. 3, a method according to a first embodiment, implemented by the carrier 1, comprises the following steps.

The method comprises a first phase, aimed at detecting a possible spoofing of which the wearer 1 would be a victim. The first phase comprises the following steps.

In a step 100, the inertial unit 12 is used to determine a position and an attitude of the carrier 1.

In a step 102, the detection module 10 determines, based on the attitude of the carrier 1, on the position of the carrier 1 and on the location data of the satellites stored in the memory, a first direction, this first direction pointing towards a first satellite of the constellation, for example the satellite S1.

In a step 104, the detection module 10 controls the antenna system 4, such that the antenna system implements the aforementioned spatial filtering, and particularly such that the attenuation sector A is oriented in the direction pointing towards the first satellite S1, having been previously determined in step 102. Thus, the main direction of attenuation is parallel to the first direction. In other words, a radio signal propagating towards the antenna system 4 in the first direction reaches the attenuation sector A and is therefore subject to the attenuation caused by the spatial filtering. On the other hand, a radio signal propagating towards the antenna system 4 in a direction which is not included in the attenuation sector A is not subject to this attenuation resulting from the spatial filtering.

The spatial filtering is a known technique per se. It can be particularly based on a phase shift of signals received by the different antennas 6a, 6b, 6c of the antenna system 4. For all intents and purposes, one embodiment of the spatial filtering is detailed in the annex, at the end of the present description.

The attenuation caused by the spatial filtering in step 104 in the attenuation sector A can be:
An attenuation called “low” attenuation, adapted so that the tracking, by the GNSS receiver 8 coupled to the antenna system 4, of a satellite is uninterrupted. For example, this low attenuation can be only 3 dB in the attenuation sector A.
An attenuation called “intermediate” attenuation, capable of interrupting the tracking by the GNSS receiver 8 of signals received by the antenna system 4, particularly in the first direction. The amplitude of such signals is reduced more by this intermediate attenuation than by the low attenuation.
A “cancellation”, i.e. attenuation such that a signal is completely eliminated by the antenna system 4.

In a step 106, the detection module 10 checks whether the antenna system 4 receives, while the attenuation sector A points towards the first satellite S1, a radio signal which meets the following conditions:
a) the received radio signal is not subject to the attenuation caused by the spatial filtering,
b) the received radio signal appears as a positioning signal emanating from the satellite S1.

To check whether the condition a) is verified, the detection module can proceed in different ways:
by analyzing a signal-to-noise ratio of the received signal (a person skilled in the art knows how to implement such an analysis), or
by checking whether a tracking of the signal, carried out by the GNSS receiver 8, was interrupted when the attenuation sector A was oriented towards the first satellite S1. It is noted that this alternative is not applicable to the low attenuation variant, in which it is precisely ensured that such an interruption does not occur.

The condition b) can be verified by analyzing the content of the signal. For this, the detection module 10 can request the GNSS receiver 8.

If these conditions a) and b) are both verified by a signal received by the antenna system 4, then there is a risk that the carrier 1 is the victim of spoofing. Indeed, point a) reveals that the signal is actually not received by the antenna system 4 in the first direction, which seems inconsistent with point b), unless it is considered that the received signal is actually not emitted by the first satellite S1, but by another entity located elsewhere, such as the emitter B.

If, on the other hand, the detection module 10 does not detect a signal received during the spatial filtering in the first direction which simultaneously verifies the conditions a) and b), the carrier 1 is in a normal situation.

The detection module 10 controls the storage in the memory of a detection result associated with the first satellite S1. This result indicates whether a signal verifying the conditions a) and b) was detected (positive result) or not (negative result).

Steps 102 to 106 can then be implemented again for other satellites of the constellation. Such repetition has the advantage of allowing the detection module 10 to obtain complementary detection results. Let us take the example of an application of steps 102 to 106 to the second satellite S2. The detection module 10:
determines in step 102 a second direction pointing towards the second satellite S2;
controls in step 104 the antenna system 4, so as to move the attenuation sector A in the second direction;
detects in step 106 whether a radio signal is received by the antenna system 4 while the attenuation sector A includes the second direction (pointing towards the second satellite S2), whether or not the received radio signal is subject to the attenuation caused by the reconfigured spatial filtering, and whether the received radio signal appears as a positioning signal emanating from the satellite; a result of this verification associated with the second satellite S2 is then stored.

The detection module 10 can for example implement these steps for each satellite of the constellation. At the end of this repetition, a plurality of results respectively associated with the satellites of the constellation is stored in the memory.

If none of these data reveals a risk of spoofing, then the method ends.

If at least one of the data reveals a risk of spoofing, then the detection module 10 triggers a second phase of the method, comprising a processing under the assumption that the antenna system 4 is the victim of spoofing. This second phase comprises the following steps.

In a step 108, the detection module 10 controls the antenna system 4, so that the attenuation sector A where the spatial filtering causes an attenuation of power is oriented in a direction that does not point towards any satellite of the constellation (step 108). More specifically, the angular sector A is reoriented so as not to include any direction that would point towards any satellite of the constellation.

In a step 110, the detection module 10 checks whether the following conditions are verified by at least one radio signal:
c) the radio signal is subject to attenuation caused by the spatial filtering of step 108,
d) this radio signal appears as a positioning signal emanating from a satellite forming part of the constellation.

The verification of the conditions c) and d) can be carried out in the same way as the verification of the conditions a) and b), respectively.

Compliance with conditions c) and d) by at least one signal is suspect, because the detection module 10 took care to ensure that the attenuation sector A does not point towards any of the satellites of the constellation in step 108. Consequently, any positioning signal actually emanating from any satellite of the constellation cannot be subject to the attenuation caused by the spatial filtering, this attenuation being specific to the attenuation sector A. This indirectly reveals that the attenuation sector A actually points towards the emitter which emits a radio signal imitating a signal emitted by one of the satellites in the constellation.

When the detection module 10 detects in step 110 that the conditions c) and d) are verified by at least one signal, the detection module 10 identifies a direction included in the attenuation sector A during the detection 110 as a spoofing direction, that is to say a direction pointing towards a jammer (step 112). The module chooses for example as a spoofing direction the main direction of attenuation at the time of detection of the fact that the conditions c) and d) are met.

As a variant, the detection module 10 can check, in addition to conditions c) and d), whether the following complementary conditions are verified:
e) there are several signals that verify the conditions c) and d),
f) these signals respectively appear as positioning signals emanating from different satellites of the constellation. This complementary verification is advantageous, because it further increases the likelihood of spoofing occurrence.

In this variant, the detection module can only trigger step 112 if conditions c), d), e) and f) are met.

Then, in a step 114, the detection module 10 controls the antenna system 4 so as to maintain the identified direction included in the attenuation sector A while the carrier 1 is moving. In this case, it is preferable to ensure that the spatial filtering applies an intermediate attenuation, and even more preferably a cancellation. This makes it possible to exclude the signal emitted by the emitter at the input of the GNSS receiver 8.

Optionally, the spatial filtering of step 114 can be adapted to cause an amplification of the power of signals received by the antenna system in an angular sector different from the attenuation sector A, for example an angular sector complementary to the sector A.

If the detection module 10 does not detect in step 110 a signal verifying the conditions c) and d) simultaneously, then the method loops back to step 108. Steps 108 and 110 are then implemented again for another direction that does not point towards any satellite.

Thus, when this step 108 is repeated, the space unoccupied by satellites of the constellation is covered “blindly” by the attenuation sector, in search of a jammer. Different strategies can be implemented to scan this space. For example, this scanning can be carried out plan by plan.

In the preceding method, a first phase made it possible to detect a jammer, and a second phase made it possible to locate and exclude this jammer.

It can be noted that, among the aforementioned possible attenuation modes, the attenuation called “low” attenuation is particularly advantageous.

Firstly, it ensures continuity of tracking of GNSS signals 8 and thus their exploitation by the carrier 8, for example to be geolocated.

Secondly, it makes the method more robust to false alarms than with “cancellation” type attenuation. Indeed, it is possible that a signal is eliminated not because of the spatial filtering, but because of the presence of a physical obstacle between the carrier and the emitter of this signal. This obstacle can be typically a part of the carrier 1 itself, for example a wing of the carrier 1 when the latter is an aircraft. Such ambiguity disappears when the attenuation called “low” attenuation is used: in this case, a signal can only be eliminated due to the presence of a physical obstacle.

The method described above can be typically repeated over time by the wearer 1, during its displacement.

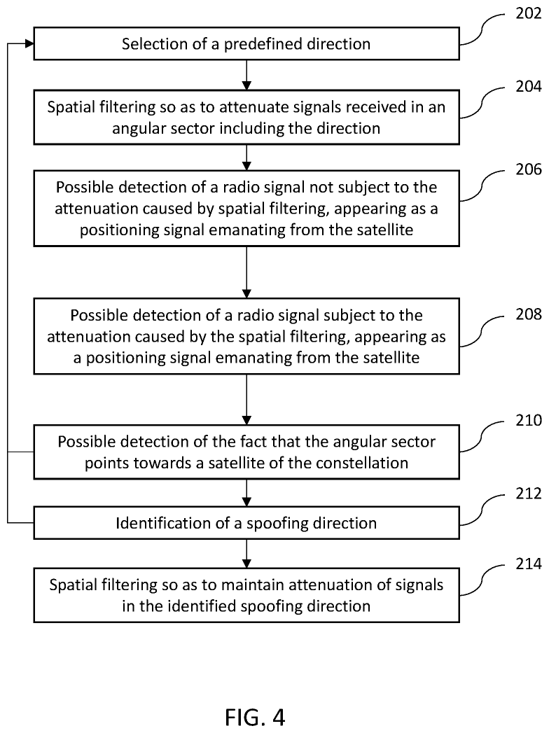

With reference to FIG. 4, a method according to a second embodiment comprises the following steps.

In a step 202, the detection module 10 selects a predefined direction. This direction is not determined as a function of satellite positions, unlike the method according to the first embodiment. Typically, this predefined direction is oriented by a predefined angle relative to a fixed reference direction. This predefined direction can thus point towards a satellite of the constellation or not, but the detection module 10 does not have this information at this stage.

In a step 204, similar to step 104, the detection module controls the antenna system 4 so as to implement a spatial filtering causing attenuation in the attenuation sector A. the attenuation sector is oriented to include the selected direction. Typically, it is ensured to make the main direction of attenuation coincide with the predefined direction.

In a step 206, the detection module 10 carries out a verification similar to the one carried out in step 106: the detection module checks whether a received signal verifies the conditions a) and b), while the attenuation sector includes the predefined direction.

Furthermore, in a step 208, the detection module 10 carries out a verification similar to the one carried out in step 110: the detection module checks whether a signal verifies the conditions c) and d), while the sector of attenuation A includes the first orientation.

In a step 210, the detection module 10 also checks whether or not the angular attenuation sector A includes or not a direction pointing towards a satellite of the constellation. In other words, the detection module 10 checks whether or not the predefined direction is close to a direction pointing towards a satellite. For this, the detection module can implement steps 100 and 102.

Steps 206, 208 and 210 can be implemented in parallel or in any order.

The verifications carried out in steps 206, 208, and 210 can result in several cases:
1) A signal is detected in step 206 which verifies the conditions a) and b) and in step 210 that the attenuation sector A points towards a satellite of the constellation.
2) A signal is detected in step 208 which verifies the conditions c) and d), and in step 210 that the predefined direction does not point towards any satellite of the constellation.
3) Other cases.

Case 1) reveals the existence of a spoofing of which the carrier 1 is the victim. But the emitter is not in the predefined direction, and it is not known in which direction this emitter is located.

In case 2), the detection module 10 identifies the predefined direction as a spoofing direction. An emitter of unwanted signals was then not only detected, but immediately located.

Case 3) does not reveal anything abnormal.

Then, the detection module 10 implements steps 202 and following for a new predefined direction, for example periodically. The new predefined direction deviates by a predefined angular deviation about a reference axis, compared to the previous direction. This angular deviation can in practice be chosen according to: i) the capacity of the antenna system to form a more or less narrow attenuation sector A; ii) the scanning speed of the sector A; and iii) the desired periodicity. This angular deviation is for example 1 degree.

Thus, by repeating the series of steps 202 to 212 multiple times, it can be ensured that the attenuation sector A moves in rotation by 360 degrees about a reference axis. During this path, jammers can be detected (case 1), or even located (case 2).

In a step 214, the detection module 10 can control the antenna system 4 so as to keep the attenuation sector pointed towards a previously identified spoofing direction. This step 214 is similar to step 114.

One advantage of the second embodiment is that the movement of the attenuation sector A is independent of the satellite constellation. But one disadvantage compared to the first embodiment is that it takes on average longer to detect a satellite spoofing.

### Annex—Exemplary Embodiment of Spatial Filtering

### Assumptions

We have an antenna array [symbol] _{M} including M (≥2) antenna elements (whose physical characteristics are known, particularly the radiation pattern and the maximum unit gain noted G_{U}) numbered from 1 to M. Unless otherwise stated (see the case of the 2^{nd} embodiment) the geometry of this array (linear, circular, matrix, any array) is arbitrary.

The antenna array [symbol] _{M} and the related receive channels have been previously calibrated. Indeed, the performance of the algorithms used for the generation of beams and notches closely depends on the user's ability to calibrate all of the hardware elements constituting the receive chain. The calibration is the operation that estimates (using signals dedicated to this task) and compensates for the amplitude and phase deviations between the channels due to the physical differences between the components and the lines constituting each unit of the receive chain (it includes one unit per channel).

An antenna array differentiates and identifies the incident radio sources according to the amplitudes and relative phases that these sources arouse at the level of the antenna elements of the array (the amplitude and phase variation induced at the level of each antenna element is materialized by a complex coefficient s indexed by the number m of the concerned antenna element).

All of these complex coefficients form a vector and are called in our jargon “spatial signature” of the radio source of interest:

$$s = ( {s}_{1} {s}_{2} ⋯ {s}_{m} ⋯ {s}_{M - 1} {s}_{M} )$$

Each coefficient sₘ, m=1 . . . M, of s incorporates information related:
to the path difference of the incident signal received by the antenna element m relative to a reference antenna element (the antenna element 1 by convention). This path difference depends on the geometry of the antenna array [symbol] _{M}, on the azimuth φ and on the elevation θ of the incident signal x. We will note it: δ_{1,m}(φ,θ) (it should be noted that δ_{1,1}(φ,θ)=0 meters). The phase variation induced by δ_{1,m}(φ, θ) is given by:

$${Φ}_{m} ( φ , θ ) = {e}^{- i \frac{2 π}{λ} {δ}_{1 , m} ( φ , θ )} = {e}^{- i {κδ}_{1 , m} ( φ , θ )}$$

where: λ and κ respectively designate the wavelength and the wave number of the incident signal.
to the physical characteristics of the antenna array (such as the radiation pattern of the constituent antenna elements, the coupling between these antenna elements, etc.). We will not go into detail about the (fairly complex) modeling of the different phenomena taken into account. We will only be concerned with the final result materialized by a simple complex coefficient. The amplitude and phase variation induced by all these phenomena is noted: Ψₘ(φ, θ)

Ultimately, each coefficient of the spatial signature is modeled as follows:

$${s}_{m} = {Φ}_{m} ( φ , θ ) {Ψ}_{m} ( φ , θ ) = {Ψ}_{m} ( φ , θ ) {e}^{- i {κδ}_{1 , m} ( φ , θ )}$$

### 1^{st} Embodiment

### 1^{st} Situation

We simply wish to create an attenuation sector (i.e. a null) whose depth are wished to be controlled (the attenuation we wish to achieve is Aₖ dB, with Aₖ≤0, compared to the maximum gain that it is possible to achieve with the considered antenna array) in the direction of one of the K satellites (indexed by k) that the GNSS receiver is tracking. We know the azimuth φₖ and the elevation θₖ of this satellite.

The spatial signature of the incident signal xₖ(t) coming from the satellite of index k is given by:

$${s}_{k} = ( {s}_{1}^{( k )} {s}_{2}^{( k )} ⋯ {s}_{m}^{( k )} ⋯ {s}_{M - 1}^{( k )} {s}_{M}^{( k )} )$$

with sₘ^{(k)}=Ψₘ^{(k)}e^{-ixδ}^{_{1,m}}^{(φ}^{ₖ}^{,θ}^{ₖ₎}

The set of weights w_{notch}^{(k)} which should be used in order to create an attenuation notch AₖdB in the supposed direction of the targeted incident source of azimuth φₖ and elevation θₖ is calculated as follows:

We form the following rectangular matrix of dimensions 2×M:

$$ℳ = ( \begin{matrix}1 \\ {s}_{k}\end{matrix} )$$

where:

$$1 = \underbrace{( 1 ⋯ 1 )}_{M}$$

We form the following square matrix of dimensions 2×2:

$$𝒜 = ( \begin{matrix}1 & 0 \\ {a}_{k} & 1\end{matrix} )$$

where:

$${a}_{k} = - {10}^{\frac{{A}_{k}}{20}}$$

We calculate the following rectangular matrix of dimensions 2×M:

[symbol]

=

[symbol]

We calculate the pseudo-inverse of Moore-Penrose of

[symbol]

$$𝒲 = {𝒩}^{†} = {{𝒩}^{H} ( {𝒩𝒩}^{H} )}^{- 1}$$

where:
(·)^{†} denotes the “pseudo-inverse of Moore-Penrose” operation
(·)^{H} denotes the “transposed+conjugated” operation

The desired set of weights is given by:

w_{notch}^{(k)}=( [symbol] )_{column 1}

### 2^{nd} Situation

We wish to create a plurality of attenuation sectors whose depth wished is to be controlled towards a subset of L satellites chosen among the K satellites that the GNSS receiver is tracking. The indices of the L satellites retained belong to the set {kₗ^{E}} with 1≤kₗ^{E}≤K and l=1 . . . L (the upper letter E means “notch(es)”).

We therefore wish to achieve a plurality of attenuations of {Aₖ_{ₗ}_{^{E}}} dB towards a plurality of satellites indexed by {kₗ^{E}}. We know the azimuths {φₖ_{ₗ}_{^{E}}} and the elevations {θₖ_{ₗ}_{^{E}}}corresponding to this plurality of satellites.

The number of notches L that can be created is limited and is given by:

L<M

The plurality of spatial signatures corresponding to the plurality of incident signals {xₖ_{ₗ}_{^{E}}(t)} coming from the plurality of satellites indexed by {kₗ^{E}} is given by:

$$\{ {s}_{{k}_{l}^{E}} \} = ( {s}_{1}^{( \{ {k}_{l}^{E} \} )} {s}_{2}^{( \{ {k}_{l}^{E} \} )} ⋯ {s}_{m}^{( \{ {k}_{l}^{E} \} )} ⋯ {s}_{M - 1}^{( \{ {k}_{l}^{E} \} )} {s}_{M}^{( \{ {k}_{l}^{E} \} )} )$$

with sₘ^{(k}^{ₗ}^{^{E)}}=Ψₘ^{(k}^{ₗ}^{^{E)}}e^{-κδ}^{_{1,m}}^{(φ}ₗ^{E,θ}ₗ^{E)}

The set of weights w_{notches}^{({k}^{ₗ}^{^{E})}} which should be used in order to create a plurality of attenuation notches {Aₖ_{ₗ}_{^{E}}} dB in the assumed directions of the plurality of incident sources of azimuth {φₖ_{ₗ}_{^{E}}} and elevation {θₖ_{ₗ}_{^{E}}} aimed is calculated as follows:

We form the following rectangular matrix of dimensions (L+1)×M:

$$ℳ = ( \begin{matrix}1 \\ \{ {s}_{{k}_{l}^{E}} \}\end{matrix} ) = ( \begin{matrix}1 \\ {s}_{{k}_{1}^{E}} \\ ⋮ \\ {s}_{{k}_{l}^{E}} \\ ⋮ \\ {s}_{{k}_{L}^{E}}\end{matrix} )$$

where

$$1 = \underbrace{( 1 ⋯ 1 )}_{M}$$

We form the following square matrix of dimensions (L+1)×(L+1):

$$𝒜 = ( \begin{matrix}- \\ a\end{matrix} ) ( 10 ) + {𝕀}_{L + 1}$$

where:

$$a = ( \begin{matrix}{a}_{{k}_{1}^{E}} \\ ⋮ \\ {a}_{{k}_{l}^{E}} \\ ⋮ \\ {a}_{{k}_{L}^{E}}\end{matrix} ) with {a}_{{k}_{l}^{E}} = - {10}^{\frac{{A}_{{k}_{l}^{E}}}{20}} , \\ 0 = \underbrace{( 0 ⋯ 0 )}_{L}$$

[symbol] _{L+1} is the identity matrix of dimensions (L+1)×(L+1)

We calculate the following rectangular matrix of dimensions (L+1)×M:

[symbol]

=

[symbol]

We calculate the pseudo-inverse of Moore-Penrose of [symbol] :

$$𝒲 = {𝒩}^{†} = {{𝒩}^{H} ( {𝒩𝒩}^{H} )}^{- 1}$$

Note: if [symbol] is square then W= [symbol] ⁻¹ (if [symbol] is invertible)

The desired set of weights is given by:

w_{notches}^{({k}^{ₗ}^{^{E})}}=(W)_{column 1}

### 2^{nd} Embodiment

### General Case

We wish to scan periodically (period T) the azimuthal angular space with an angular sector having an attenuation of A dB. We have an antenna array [symbol] _{M} including M (≥2) antenna elements. The geometry of the array is linear, that is to say all its constituent elements are disposed at regular intervals d on a segment of length (M−1)d) and the reference element is the element indexed by 1 located at the right end of the segment represented in the figure. We considered this geometry in preference to another geometry (circular for example) because of the ease with which it allows dealing with the particular case that ultimately interests us: M=2.

The spatial signature of the incident signal x whose direction of arrival is φ(t) is given by:

$$s = ( {s}_{1} {s}_{2} ⋯ {s}_{m} ⋯ {s}_{M - 1} {s}_{M} )$$

with

$${s}_{m} = {Φ}_{m} ( φ , θ ) {Ψ}_{m} ( φ , θ ) = {Ψ}_{m} ( φ , θ ) {e}^{- i {κδ}_{1 , m} ( φ , θ )}$$

where: λ and κ respectively denote the wavelength and the wave number of the incident signal.

The path difference between the reference element 1 and the element m is given by:

$${δ}_{1 , m} ( φ ( t ) ) = d ( m - 1 ) cos ( φ ( t ) )$$

For simplicity's sake, we will assume that the antenna elements constituting the antenna array can be compared to points whose radiation pattern is isotropic.

The spatial signature is then written:

$$s ( t ) = ( 1 {e}^{- i κ d cos ( φ ( t ) )} ⋯ {e}^{- i κ d ( m - 1 ) cos ( φ ( t ) )} ⋯ {e}^{- i κ d ( M - 2 ) cos ( φ ( t ) )} {e}^{- i κ d ( M - 1 ) cos ( φ ( t ) )} )$$

The angular space being scanned periodically, we have: φ(t+T)=φ(t). Therefore, if we subdivide time t into elementary time intervals of duration τ=T/N, it suffices to calculate once and for all and record in memory a sequence of N sets of weights to operate continuously, repeating it indefinitely, an angular scan of resolution Δφ=2π/N: φ(ητ)=ηΔφ with n=0 . . . N−1. We will therefore replace s(t) by s(ητ) in the following.

The set of weights w_{notch}^{φ(ητ)} that should be used in order to create an attenuation sector causing an attenuation of Aₖ dB in the supposed direction of the targeted incident source of azimuth φ(ητ) is calculated as follows:

We form the following rectangular matrix of dimensions 2×M:

$$ℳ = ( \begin{matrix}1 \\ s ( n τ )\end{matrix} )$$

where

$$1 = \underbrace{( 1 ⋯ 1 )}_{M}$$

We form the following square matrix of dimensions 2×2:

$$𝒜 = ( \begin{matrix}1 & 0 \\ a & 1\end{matrix} )$$

where:

$$a = - {10}^{\frac{A}{20}}$$

We calculate the following rectangular matrix of dimensions 2×M:

[symbol]

=

[symbol]

We calculate the pseudo-inverse of Moore-Penrose of [symbol] :

$$𝒲 = {𝒩}^{†} = {{𝒩}^{H} ( {𝒩𝒩}^{H} )}^{- 1}$$

In our case, the formal calculation gives:

$$\begin{matrix}𝒲 = {( 𝒜ℳ )}^{H} {( ( 𝒜ℳ ) {( 𝒜ℳ )}^{H} )}^{- 1} \\ = {ℳ}^{H} {{𝒜}^{T} ( {𝒜ℳℳ}^{H} {𝒜}^{T} )}^{- 1} \\ = {ℳ}^{H} {𝒜}^{T} {𝒜ℳℳ}^{H} {{𝒜}^{T} ( 𝒜 ( \begin{matrix}M & \overline{Z} \\ Z & {M}^{′}\end{matrix} ) {𝒜}^{T} )}^{- 1} \\ = {ℳ}^{H} {{𝒜}^{T} ( \begin{matrix}M & aM + \overline{Z} \\ aM + Z & {a}^{2} M + 2 a ℛ ( Z ) + M\end{matrix} )}^{- 1} \\ = \frac{1}{{M}^{2} - {\vert Z \vert}^{2}} {ℳ}^{H} {𝒜}^{H} ( \begin{matrix}{a}^{2} M + 2 a ℛ ( Z ) + M & - Am - \overline{Z} \\ - aM - Z & M\end{matrix} ) \\ = \frac{1}{{M}^{2} - {\vert Z \vert}^{2}} ( {1}^{T} a {1}^{T} {( s ( n τ ) )}^{H} ) ( \begin{matrix}{a}^{2} M + 2 a ℛ ( Z ) + M & - aM - \overline{Z} \\ - aM - Z & M\end{matrix} ) \\ = \frac{1}{{M}^{2} - {\vert Z \vert}^{2}} ( ( M + a \overline{Z} ) {1}^{T} - ( aM + Z ) {( s ( n τ ) )}^{H} - \overline{Z} + {M ( s ( n τ ) )}^{H} )\end{matrix}$$

where:

$$Z = 1 {( s ( n τ ) )}^{H} = {\sum }_{m = 1}^{M} {e}^{- i κ d ( m - 1 ) cos ( φ ( n τ ) )}$$

[symbol] (Z) denotes the real part of Z
(̅·̅)̅ denotes the “conjugate” operation

The desired set of weights is given by:

w_{notch}^{φ(ητ)}=( [symbol] )_{column 1}

In our case, the desired set of weights is given by:

$${w}_{notch}^{φ ( n τ )} = \frac{1}{{M}^{2} - {\vert Z \vert}^{2}} ( ( M + a \overline{Z} ) {1}^{T} - ( aM + Z ) {( s ( n τ ) )}^{H} )$$

### Particular Case

In a particular case, the antenna array includes M=2 antenna elements.

In this case, the set of weights sought to project an angular sector causing an attenuation of A dB in the direction of azimuthal angle φ(ητ) is given by:

$${w}_{notch}^{φ ( n τ )} = \frac{1}{4 - {\vert Z \vert}^{2}} ( ( 2 + a \overline{Z} ) ( \begin{matrix}1 \\ 1\end{matrix} ) - ( 2 a + Z ) {( s ( n τ ) )}^{H} )$$

where:

$$s ( n τ ) = ( 1 {e}^{- i κ d cos ( φ ( n τ ) )} ) \\ Z = 1 + {e}^{- i κ d cos ( φ ( n τ ) )}$$

1. A method comprising:
performing spatial filtering causing an attenuation of power of radio signals received by an antenna system in an angular sector, the spatial filtering being adapted so that the attenuation does not interrupt a tracking, by a GNSS receiver coupled to the antenna system, of a radio signal received by the antenna system in any direction;
detecting that the following conditions are met: a radio signal is received by the antenna system while the angular sector includes a direction pointing towards a satellite forming part of a constellation of positioning satellites, the received radio signal is not subject to the attenuation caused by the spatial filtering, and the received radio signal appears as a positioning signal emanating from the satellite;
upon detecting that the conditions are met, implementing a processing under the assumption that the antenna system has been spoofed.

2. The method of claim 1, wherein the detecting is repeated for several satellites forming part of the constellation.

3. The method of claim 1, wherein the processing comprises:
detecting that a second signal appearing as a positioning signal emanating from a satellite forming part of the constellation is subject to an attenuation caused by the spatial filtering while the angular sector does not include any direction pointing towards any satellite of the constellation,
identifying a direction included in the angular sector during detection as a direction pointing towards an emitter by which the antenna system has been spoofed.

4. The method of claim 1, wherein the processing comprises:
detecting that second signals appearing respectively as positioning signals emanating from different satellites forming part of the constellation are simultaneously subject to the attenuation caused by the spatial filtering while the angular sector does not include any direction pointing towards any satellite of the constellation,
identifying a direction included in the angular sector during the detection as a direction pointing towards a jammer.

5. The method of claim 4, wherein the antenna system is in a mobile carrier, and the processing comprises:
performing spatial filtering so as to maintain the direction identified in the angular sector during a displacement of the mobile carrier.

6. The method of claim 1, further comprising:
determining the direction pointing towards the satellite before performing the spatial filtering,
controlling the antenna system based on the direction pointing towards the satellite, so as to orient the angular sector in the direction pointing towards the satellite.

7. The method of claim 1, comprising steps of:
controlling the antenna system so as to move the angular sector in rotation, the angular sector occupying a succession of orientations during the rotation,
during the rotation, detecting that the angular sector includes the direction pointing towards the satellite.

8. The method of claim 1, comprising determining the direction pointing towards the satellite from an attitude of a carrier comprising the antenna system, the attitude being determined based on data provided by an inertial unit.

9. The method of claim 1, wherein the antenna system comprises at least three planar antennas.

10. A device comprising:
an antenna system configured to perform spatial filtering causing an attenuation of power of radio signals received by the antenna system in an angular sector, the spatial filtering being adapted so that the attenuation does not interrupt the tracking, by a GNSS receiver coupled to the antenna system, of a radio signal received by the antenna system in any direction,
a detector configured to:
detect that the following conditions are met: a radio signal is received by the antenna system while the angular sector includes a direction pointing towards a satellite forming part of a constellation of positioning satellites, the received radio signal is not subject to the attenuation caused by the spatial filtering, and the received radio signal appears as a positioning signal emanating from the satellite, and
upon detecting that the conditions are met, implement a processing under the assumption that the antenna system has been spoofed.

11. A mobile carrier comprising the device of claim 10.
